(19) United States
(12) Patent Application Publication
(10) Pub. No.: US 2005/0075026 A1
(43) Pub. Date: Apr. 7, 2005

(54) Rigidized ceramic fiber batting board and method of producing same

(75) Inventor: Robert A. DiChiara JR., Carlsbad, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/676,506

(22) Filed: Oct. 1, 2003

(51) Int. Cl. B32B 5/02; B32B 5/16; D04H 1/00; D04H 3/00; B32B 3/00; D04H 13/00; B32B 11/00; D04H 5/00

(52) U.S. Cl. 442/172; 442/149; 442/178; 428/213; 428/215; 428/217; 428/218; 428/219; 428/220; 428/208; 428/210; 428/146; 428/147; 428/113

(57) ABSTRACT

A rigidized ceramic fiber batting board and a method of forming the rigidized ceramic fiber batting board having uniform density and composition through the thickness of the board by applying a water-based organic binder having reverse thermal gelation properties, such as methylcellulose and methylcellulose derivatives, to the ceramic fibers, gelling the binder solution, and drying the binder to form the rigid batting.

### FIELD OF THE INVENTION

The invention relates to a method of temporarily rigidizing a ceramic fiber batting board. The invented method may be used during the fabrication of high-temperature flexible insulation such as that used in the thermal protection systems of reusable launch vehicles.

### BACKGROUND OF THE INVENTION

Reusable launch vehicles (RLV's) such as the Space Shuttle Orbiter utilize reusable thermal protection systems (TPS's) for thermal protection during launch, orbit, and reentry into the atmosphere. The TPS must simultaneously perform as a radiator, a reflector, and an insulator in order to, respectively, emit heat from the surface of the vehicle, prevent on-orbit heating, and protect the structure of the vehicle from residual heat flux.

It has become commonplace to use flexible blanket insulation, often called flexible insulation (FI), in place of ceramic tiles as a part of the TPS of RLV's. The flexible insulation can withstand multiuse temperatures of 650° C., and may therefore be used on many of the upper surfaces and leeward surfaces of the Orbiter which do not experience temperatures in excess of 650° C. during reentry.

The flexible insulation is favorable for use on RLV's because it is much easier to maintain and replace than individual insulation tiles. The flexible insulation is also able to withstand undulations and vibrations of the underlying vehicle better than the ceramic tiles.

The flexible insulation is basically a layer of pliable silica, alumina or other ceramic batting sandwiched between outer and inner layers of ceramic fabric. The outer layer, batting, and inner layer are loosely sewn together using ceramic thread. The layers are typically sewn at about 1 inch intervals to form a blanket with an undulating quilt-like pattern. The edges of the blanket may be left open for later alteration, or the outer layer may be folded downwards to overlap the sides of the blanket and sewn into position.

It is advantageous to temporarily rigidize the ceramic batting during fabrication of the flexible insulation. By rigizing the batting, the batting may be machined to tight tolerances, the surfaces may be easily smoothed, and sharp edges and corners may be formed. By machining the batting prior to the quilting step, the FI may be produced with exacting size and shape. Also, stitched corners may be recessed into the rigidized batting.

Batting boards of rigidized alumina have previously been prepared by soaking the batting with a water-based organic starch binder. After evaporation of the water, the dried starch forms a coating upon the fibers of the batting and effectively rigidizes the batting. After the insulation blanket is assembled, the blanket is heated above the decomposition temperature of the starch so that the starch vaporizes and the batting regains its flexibility.

Though starch binders have been successfully used in the past, there are several inadequacies associated with the use of starch binders. Most of the inadequacies are associated with poor distribution of the dried starch within the batting. During drying, the starch tends to become more concentrated near the faces of the batting. The concentration gradient causes variations in stiffness and density through the thickness of the batting and may even form a hard crust of starch upon the outer surface of the batting. The stiffness and density variations and surface crust formation cause difficulties in machining the batting to an exact thickness and cause additional problems during sewing of the blanket.

Improvements in quality and efficiency of FI blanket fabrication could be achieved if a rigidized ceramic fiber batting board could be supplied with uniform density and binder distribution. It is, therefore, desired to provide a rigidized ceramic batting board having a uniformly distributed binder, and further desired to provide a method of producing the desired batting board.

### SUMMARY OF THE INVENTION

The invention is a rigidized ceramic fiber batting board and a method of forming the rigidized ceramic fiber batting board that has a uniform density and composition through the thickness of the board. As such, the quality and efficiency of FI blanket fabrication incorporating the rigidized ceramic fiber batting board of the present invention is be improved. The invention also encompasses the use of the rigidized batting board in the production of flexible insulation blankets.

The batting board is rigidized with a water-based organic binder system having reverse thermal gelation properties. Such binder systems include aqueous solutions of polymers derived from cellulose, such as methylcellulose and methylcellulose derivatives.

According to an embodiment of the invention, a rigidized batting board of continuous ceramic fiber is formed. A binder having reverse gelation properties is applied to a layer of continuous ceramic fiber batting as a water-based solution and the binder solution is allowed to saturate the batting. The temperature of the batting is increased and, as the temperature of the solution within the batting is elevated, the binder gels within the batting. The binder solution dries at the elevated temperature. The gelled binder remains evenly dispersed within the batting during drying unlike starch and other previously used binders that tend to migrate during the drying process. Upon drying, the binder coats the ceramic fibers and fixes the fibers to one another within the batting, thus rigidizing the batting. The resulting board has a uniform density because the binder gels uniformly throughout the batting prior to drying and does not migrate during processing of the batting. The resulting rigidized batting board may be easily fabricated with a density as low as about 8 lbs/ft³, and may be fabricated with densities of 20 lbs/ft³ or higher. Further, the binder does not cause the batting to shrink substantially, so the batting is not locally compressed or expanded during drying of the binder solution.

According to an alternative embodiment, a rigidized batting board of chopped ceramic fibers is formed. Chopped ceramic fiber is first supplied, such as by chopping and dispersing continuous ceramic fiber using a high shear mixer in water. The slurry is then vacuum formed through a porous screen to separate the batting from the water of the slurry. An aqueous solution of binder having reverse gelation properties is poured on top of the vacuum formed batting and allowed to saturate the batting, or the solution of binder is pulled through the batting using vacuum. The saturated fiber batting is then pressed to its desired size and the temperature of the batting is elevated above the gelation temperature of the binder solution. At such temperature the binder gels within the batting and the binder solution eventually dries. The gelling and drying steps may occur in an oven, and may take place with or without applied pressure.

According to another alternative embodiment, a rigidized batting board of chopped ceramic fibers is formed by adding the reverse thermal gelation binder to an aqueous slurry of chopped fibers prior to forming the fibers upon a screen. The temperature of the slurry is lowered and the binder goes into solution with the water in the slurry. The slurry is vacuum formed as a green batting layer to a particular thickness and pressed. The temperature of the batting is elevated and the binder gels within the batting prior to or after the pressing step. At the elevated temperature, the water of the solution eventually evaporates and the batting is dried. The gelled binder remains well dispersed within the batting as it dries upon the ceramic fibers, thus uniformly adhering the fibers to one another and forming a batting board with uniform density. The resulting density of the vacuum formed board is similar to the continuous fiberboard, as low as about 8 lbs/ft³, and as high as 20 lbs/ft³ or higher.

The rigidized board is easily machined to tight dimensional tolerance. Also, the rigidized board may be easily sewn with ceramic thread. Because of the uniform density, the ceramic thread is less prone to break during sewing. As a further advantage, the dried binder acts as a lubricant to the ceramic thread during sewing, so the chance of thread breakage is further diminished.

After fabrication of the insulation blanket, the batting is heat cleaned by heating the binder above the decomposition temperature of the binder which causes the binder to volatize and to escape the batting. After removal of the binder, the batting regains its pliable character, and the density of the batting is reduced. For instance, rigidized batting with a density of 8 lbs/ft³ is reduced to a density of about 6-7 lbs/ft³ by removal of the binder.

As shown above, there are many advantages to the use of reverse thermal gelation binders in the formation of rigidized ceramic fiber batting boards. Further, the invented batting board and method of rigidizing the batting are relatively low cost and may be easily scaled to any size. Use of binders such as methylcellulose provide non-hazardous and environmentally friendly alternatives to previous methods of rigidizing batting boards.

### BRIEF DESCRIPTION OF THE DRAWINGS

Having thus described the invention in general terms, reference will now be made to the accompanying drawings, which are not necessarily drawn to scale, and wherein:

FIG. 1 is a flowchart showing a method of forming rigidized ceramic batting, and of optionally making a flexible insulation blanket from the rigidized batting, in accordance with an embodiment of the invention;

FIG. 2 is a flowchart showing a method of forming rigidized ceramic batting, and of optionally making a flexible insulation blanket from the rigidized batting, in accordance with an alternative embodiment of the invention; and,

FIG. 3 is a flowchart showing a method of forming rigidized ceramic batting, and of optionally making a flexible insulation blanket from the rigidized batting, in accordance with an another alternative embodiment of the invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

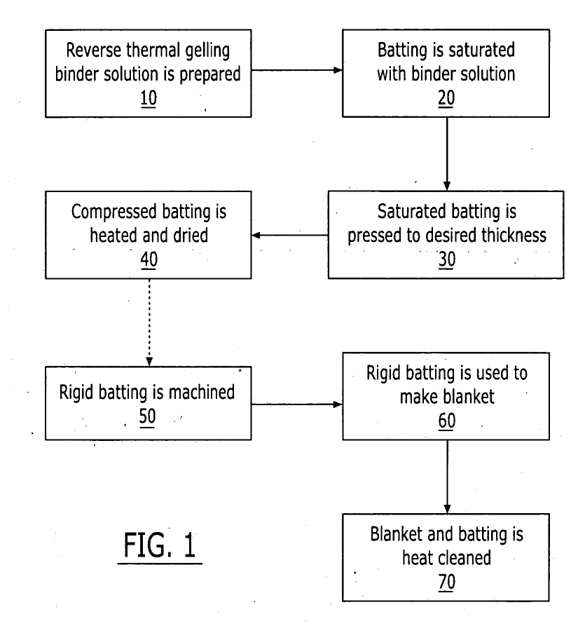

Referring to FIG. 1, according to an embodiment of the invention, an aqueous solution of a reverse thermal gelling binder is prepared below the gelation temperature of the binder in solution at step 10. After preparation of the binder solution, the solution is applied at step 20 to one or more layers of the continuous ceramic fiber batting until the batting is saturated with the solution. To saturate the batting, the solution may be poured over the batting, the batting may be temporarily submerged in the solution, or any other method may be used to saturate the batting with the solution.

Fiber batting is often supplied in preformed thicknesses. If multiple layers of a preformed batting are needed to form a rigid batting board of a desired thickness, multiple layers of batting may be stacked upon one another prior to or after saturation with the solution. If the density of the batting is to be increased, then saturated batting is prepared with a thickness greater than the final desired thickness in anticipation of pressing the batting to increase its density.

After the batting is saturated and the batting layers are assembled, if necessary, the saturated batting layers are placed between plates that are coated with Teflon® or with a release coating and pressed to a final desired thickness at step 30. The pressed, saturated green batting material has a density of about 5.0 lbs/ft³ to about 24.0 lbs/ft³, and preferably about 8 lbs/ft³ to about 12 lbs/ft³. While under pressure, the batting is heated at step 40 above the gelation point of the binder in solution for a time sufficient to gel the binder and evaporate the water from the solution. After the binder has gelled and the water has evaporated from the solution, the batting is rigid.

The rigidized batting may optionally be machined at step 50 to very exact dimensions. Once machined, the rigid batting board may optionally be sewn into an insulation blanket using techniques' previously known in the art of producing flexible insulation blankets for aerospace applications.

Once the rigidity of the batting is no longer desired, the batting is heat cleaned at step 70. To heat clean the batting, which is typically incorporated into an insulation blanket, the batting is heated to a temperature above the volatilization temperature of the binder until substantially all of the binder volatilizes and escapes from the batting and the batting regains its pliable characteristics. The density of the pliable batting will be reduced from the green density by roughly 15% to 30%. For instance, a rigidized board made by saturating the batting with a 2 wt % methylcellulose solution that is pressed and dried has a density of about 8 lbs/ft³, but after the board is placed into a blanket and heat cleaned, the batting density is reduced to about 6 lbs/ft³ to 7 lbs/ft³.

The rigidized batting board and method of making the rigidized batting board make use of binder systems having reverse thermal gelation properties. In general, “reverse thermal gelation” is the phenomena whereby a solution of a polymer spontaneously increases in viscosity, and in many instances transforms into a semisolid gel, as the temperature of the solution is increased above the gelation temperature of the polymer. The binder of the invention is an organic polymer that exhibits reverse thermal gelation properties in aqueous solutions. When cooled below the gelation temperature, the binder spontaneously reverses to reform the lower viscosity solution.

Examples of reverse thermal gelling binders include cellulose derivatives such as etherified cellulose, including alkyl celluloses, hydroxyalkyl celluloses and alkylhydroxyalkyl celluloses. Particular examples are methylcellulose, hydroxyethyl cellulose, hydroxypropyl cellulose, hydroxypropyl methylcellulose, and the like.

Exemplary methylcellulose derivatives for use with this invention are cellulose compositions substituted with methyl groups and any additional substitution groups that result in a methylcellulose derivative having reverse gelation properties. In addition to methyl substitution, substitution may also be made with hydroxypropyl and hydroxybutyl groups. The viscosity of the methylcellulose may be varied by varying the degree of substitution with hydroxypropyl and hydroxybutyl moieties, and by varying the average molecular weight of the methylcellulose polymer.

As an example of preparation of a binder solution, the aqueous solution may be prepared with from 0.1 wt % to 5.0 wt % methylcellulose, preferably 2.0 wt % to 3.0 wt %, and is prepared in sufficient quantity to saturate a pre-formed layer of continuous ceramic fiber batting of chosen size and thickness. To make up the solution, dried methylcellulose in a quantity equal to the total desired amount of methylcellulose for the solution is added to a first portion of water that comprises approximately ⅓ to ⅕ the amount of water needed to make up the total solution. The water is pre-heated or heated to a temperature that maintains the methylcellulose in a stable dispersed suspension, usually about 90° C. This hot dispersed suspension is then slowly added (while continually mixing) to a second portion of water that comprises the remaining amount of water to result in the total water of solution. The second portion of water is cold, usually less than about 20° C. and typically about 5° C., and the suspension dissolves in the cold water to form a thickened solution. After a layer of batting is saturated with the methylcellulose solution and pressed, the binder is gelled and dried by elevating the temperature of the batting to a temperature between about 45° C. and about 175° C. After the binder is dried, the resulting board has a methylcellulose content of about 5 wt % to about 20 wt %. The batting may be heat treated by heating the batting to a temperature of about 425° C. to about 550° C. until substantially all of the methylcellulose binder volatilizes.

Methylcellulose and methylcellulose derivatives are available as METHOCEL™ products from Dow Chemical Co., Midland, Mich. METHOCEL™ binders bum out easily and are also very inexpensive, making them a very cost effective system. Various versions of the available METHOCEL™ binders dissolve into water as solutions at temperatures from about 5° C. up to about 25° C. A particularly preferred METHOCEL™ binder is product number A15LV, since it has a low viscosity (15 centipoise measured using a bhlohde capillary tube viscometer at 2% concentration at 20° C.) and develops a strong gel cell structure at 48° C. METHOCEL™ binders are available in a variety of compositions with varying amounts of hydroxypropyl and hydroxybutyl additions to the methylcellulose.

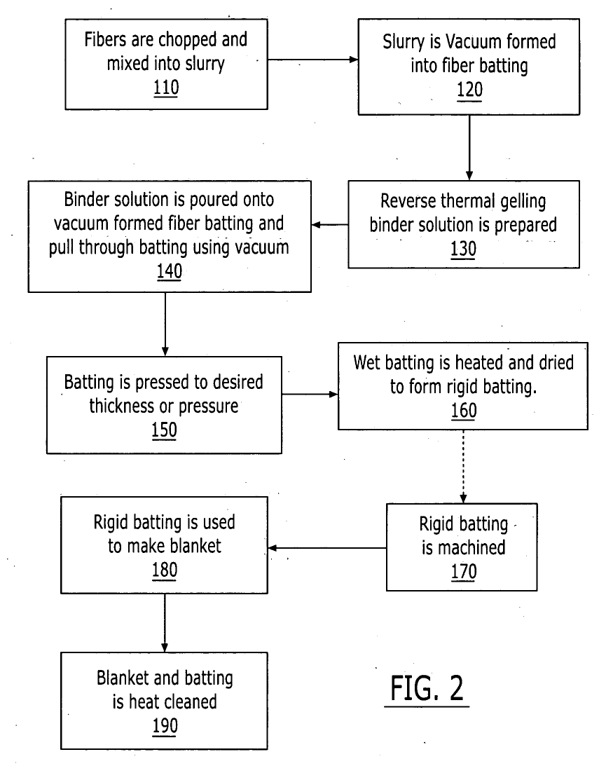

Referring to FIG. 2, according to an alternative embodiment, the rigidized ceramic fiber batting board may be prepared from a chopped fiber slurry. A fiber-water mixture is prepared at step 110 having adequate water to maintain the fiber in a uniform slurry. The slurry is vacuum formed at step 120 onto a screen mold to yield a shaped preform. Specific techniques for vacuum forming ceramic fiber batting are known in the art of insulation blanket formation. Vacuum forming of the slurry may be used to produce batting of any desired thickness or shape, and batting is typically formed with a thickness of ¼-inch to 4 inches.

An aqueous solution of binder is prepared at step 130. An exemplary binder solution may be the methylcellulose binder solution described previously with respect to the continuous fiber embodiment. Once the slurry has been vacuum formed into a layer of batting having a desired thickness and shape, the aqueous solution of binder is poured on top of the fiber batting and pulled trough the fiber batting using vacuum at step 140. The amount of binder solution poured through the batting is about twice the open volume of the porosity of the fiber batting.

The vacuumed formed batting is pressed to a desired thickness and shape in step 150, the temperature of the batting is increased at step 160 above the vaporization temperature of the water, but below the volatilization temperature of the binder in the binder solution. At this temperature, the binder gels within the ceramic batting and eventually dries to form an adhesive coating on the fibers of the slurry. Once dried, the resulting product is a rigid ceramic batting board.

As with the continuous fiber embodiment of the invention, the batting may optionally be machined to a desired dimension and in step 180 the rigid ceramic batting may optionally be incorporated into a blanket manufacturing operation. After formation of the blanket, the batting may then be heat cleaned in step 190.

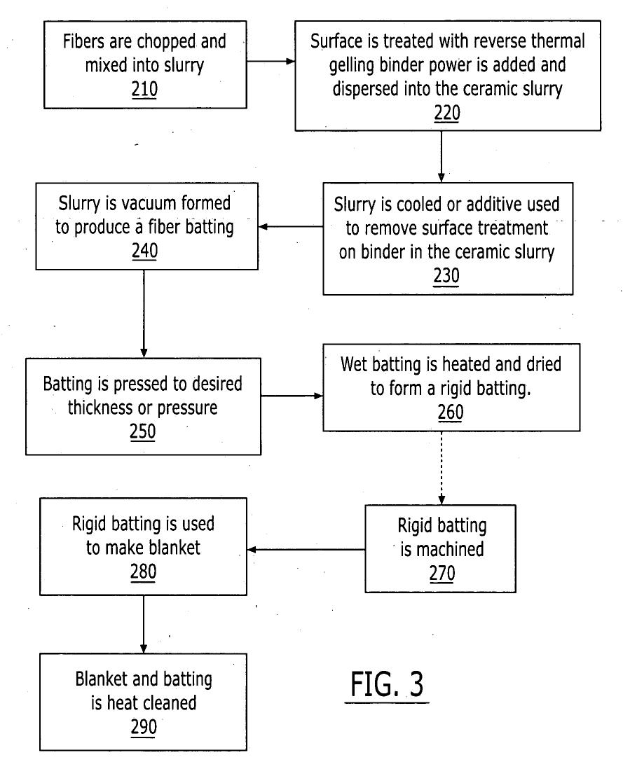

Referring to FIG. 3, according to another alternative embodiment, the rigidized ceramic fiber batting board may be prepared from a slurry containing both the chopped ceramic fiber and the reverse thermal gelling binder. A fiber-water mixture is prepared at step 210 having adequate water to maintain the fiber in a uniform slurry preferably agitated in a mixer to disperse the fibers and breakup any clumps.

A powder of surface-treated reverse thermal gelling binder powder, such as a methylcellulose powder, is added in an amount from about 0.1 wt % to about 5.0 wt %, and preferably about 2 wt % with respect to the water content of the slurry at step 220. The slurry is cooled to a temperature below the gelling temperature of the binder solution or an additive is used to remove the surface treatment on the powder surface allowing the powder to dissolve in the water in step 230.

The surface treated powders are produced to make it easier to make the binder solutions. Normally, the reverse thermal gelation powders need to be dispersed in hot water (dispersed mixture of powder and liquid) and this mixture is slowly added to cold water in order to dissolve the binder. Otherwise, the powders tend to clump and not dissolve properly. The surface treated powders have a coating on the outside surface of the powder particles to prevent the powder from dissolving in water. After the powder is dispersed in the water the pH is changed to dissolve the surface coating and cause the powder to dissolve. Therefore, the use of the surface treated powders is useful in carrying out the embodiment wherein the fiber and powder are mixed in a common slurry, and may also be useful in producing binder solutions of the other embodiments of the invention.

Examples of surface treated binder powders are METHOCEL™ K4M-S or J5M-S methylcellulose powders available from Dow Chemical Co., Midland, Mich. The surface treatment of the powders are removed or rendered inactive by elevating the pH of the aqueous solution in which the powder is dispersed to about 8.5 or 9. These binders dissolve in aqueous solution at about 25° C. at concentrations of about 0.1 wt % to about 5.0 wt % by weight of water in the slurry.

After the binder has been dissolved into the slurry, the cooled slurry is vacuum formed at step 240 onto a screen mold to yield a shaped preform. Specific techniques for vacuum forming ceramic fiber batting are known in the art of insulation blanket formation. Vacuum forming of the slurry may be used to produce batting of any desired thickness or shape, and batting is typically formed with a thickness of ¼-inch to 4 inches.

Once the slurry has been vacuum formed into a layer of batting, the batting is pressed to a given height or pressure in step 250. The batting is then heated and dried at a temperature above the gelation temperature of the binder solution in step 260 having a desired thickness and shape. Once dried, the resulting product is a rigid ceramic batting board that may optionally be machined, in step 270, woven into a flexible insulation blanket, step 280, and heat cleaned, step 290.

The embodiments of the invention may be modified through the use of various types of fibers, binders, and mixing and heating regimens. For instance, the ceramic fiber of the batting may be any ceramic fibers capable of resisting degradation upon exposure to extreme heating, and are preferably selected from alumina fibers, silica fibers, aluminosilica fibers, aluminoborosilicate fibers, and combinations thereof. The fibers may have a diameter of about 1 to about 5 microns, and preferably about 3 microns.

The length of the fibers in the batting generally determines the orientation of the fibers. Fibers with a length of greater than about 4 inches are considered “continuous” fibers, and are used to form a batting having a generally aligned fiber orientation. For purposes of this invention, continuous fibers are generally pre-formed into layers of batting material prior to being soaked with a methylcellulose solution. Fibers with a length of less than about 4 inches are considered “chopped” fibers. The chopped fibers generally form a batting material having a random arrangement of fibers.

The solutions of binders having reverse thermal gelation properties are unlike most binders in that most organic binders dissolve more readily and reduce viscosity with temperature. Reverse gelation organic binders dissolve only in cold water. When heated, instead of continually dropping, the viscosity dramatically rises at a given temperature and gels before the water of the solution is evaporated. The gelation temperature of the solution may vary widely depending upon the binder used and the concentration of the binder in the solution. For the exemplary methylcellulose binders, gelling temperature typically ranges from about 45° C. to about 70° C. for a solution of about 2 wt % binder depending on the degree to which and the constituents with which the methylcellulose is substituted.

The binder may also be prepared in different viscosities by varying the amount of binder in solution. As an example, solution concentration of methylcellulose binder solutions of 2 wt % to 3 wt % is preferred, but the typical range of concentration is 0.1 wt % to 5 wt %. The concentration is preferably adequate to properly rigidize the batting but low enough to allow easy heat cleaning, since, upon heat-cleaning of the blanket, it is important that the binder easily bums out leaving no residue.

Though methylcellulose has been used as an exemplary binder in portions of this disclosure, the invention is broadly applicable to any other organic polymer binders that have reverse thermal gelation properties in aqueous solution, that adhesively bond to ceramic fibers when dried from solution, and that readily decompose above the vaporization temperature of water but below the decomposition temperature of ceramic fiber.

### EXAMPLES

Fabrication of Methylcellulose Solution

An amount of METHOCEL™ A15LV methylcellulose polymer powder equivalent to 2 wt % of a 2000 ml volume of water is measured. The METHOCEL™ powder is first added to 500 ml of hot water at 90 C. and allowed to form a uniform suspension. This hot dispersed suspension is then-slowly added to 1500 ml of cold water at about 5° C. As the suspension dissolves in the cold water the solution thickens.

Fabrication of Rigidized Continuous Batting

A 6″×6″×2″ thick board was formed using 9 layers of continuous Saffil™ AC alumina fiber matting available from Thermal Ceramics, Elkhart, Ind. Each matting layer was cut with a template to size and 3 layers were stacked at a time. For each 3 layer stack, ˜500 ml of the 2% METHOCEL™ solution was poured over the stack to saturate the batting. The groups of saturated batting were stacked upon one another to acquire the required thickness. The saturated batting layers were placed between Teflon™ coating covered plates and pressed to a 2″ thickness. The batting was then heated to ˜80° C. for 2 hours to gel the binder and evaporate the water. The density of the resultant dried rigidized board using the 2% solution was about 8 lb/ft³. The rigidized batting was sewn between two layers of ceramic fabric and formed into an insulation blanket. The blanket was heat cleaned 8 hours after which the batting density in the blanket was about 7 lb/ft³.

Fabrication of Rigidized Chopped Batting

A 12″×12″×1″ thick board was formed using continuous Saffil™ AC alumina fiber matting. The continuous Saffil™ AC alumina fiber matting (600 grams) was fed into a high shear mixer containing 5 gallons of water forming a fiber slurry. The slurry was then cast into a box containing a screen at the bottom and a vacuum was pulled separating the fiber and the water. A half a gallon of the 2% methlycellulose solution was poured on top of the fiber and the vacuum pulled the methocellulose solution through the fiber matt. The mat was pressed, removed from the casting box and dried at 80° C. over night to form a rigidized batting board.

Fabrication of Rigidized Chopped Batting (Alternative)

A 12″×12″×1″ thick board was formed using continuous Saffil™ AC alumina fiber matting. The continuous Saffil™ AC alumina fiber matting (600 grams) was fed into a high shear mixer containing 5 gallons of water forming a fiber slurry. METHOCEL™ K4M-S surface treated methlycellulose power was added to the water and dispersed with the high shear mixer. The amount of methocellulose power added was equivalent to 2% methycellulose water solution. Ammonium hydroxide was added to the slurry in an amount sufficient to raise the pH of the solution to 8.5 and the slurry was cooled to 5° C. over night allowing the methylcellulose to dissolve. The slurry was then cast into a box containing a screen at the bottom and a vacuum was pulled to separate the wetted fiber and the excess methlycellulose water solution. The mat was pressed, removed from the casting box, and dried at 80° C. over night to form a rigidized batting board.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A rigidized ceramic batting board comprising:
a plurality of ceramic fibers; and,
a binder disposed on the fibers and interlocking the fibers with one another,
wherein the binder exhibits reverse thermal gelation properties in aqueous solution.

2. The ceramic batting board of claim 1, wherein the binder is a cellulose derivative having reverse thermal gelation characteristics in aqueous solution.

3. The ceramic batting board of claim 1, wherein the binder is selected from the group consisting of methylcellulose and methylcellulose derivatives.

4. The ceramic batting board of claim 3, wherein the binder is selected from the group consisting of methylcellulose, hydroxypropyl-methylcellulose, hydroxybutyl-methylcellulose, and combinations thereof.

5. The ceramic batting board of claim 1, wherein the plurality of ceramic fibers are selected from the group consisting of alumina, silica, aluminosilicate, aluminoborosilicate, and combinations thereof.

6. The ceramic batting board of claim 5, wherein the ceramic fibers are continuous.

7. The ceramic batting board of claim 5, wherein the ceramic fibers are chopped.

8. The ceramic batting board of claim 1, wherein the batting board has a uniform density throughout the thickness of the board.

9. The ceramic batting board of claim 8, wherein the batting board has a density of between about 5 lbs/ft³ and about 24 lbs/ft³.

10. The ceramic batting board of claim 3, wherein the board is about 5 wt % to about 20 wt % binder.

11. A method of forming a rigid ceramic fiber batting material, comprising the steps of:
applying an aqueous solution of a binder to at least one layer of a pre-formed ceramic fiber batting;
gelling at least a portion of the binder within the batting by warming the binder solution; and,
evaporating the water from the batting layer at a temperature above the gelation temperature of the binder.

12. The method of forming rigid batting material of claim 11, wherein the binder is a cellulose derivative having reverse thermal gelation characteristics in aqueous solution.

13. The method of forming rigid batting material of claim 12, wherein the binder is selected from the group consisting of methylcellulose and methylcellulose derivatives.

14. The method of forming rigid batting material of claim 13, wherein the binder is selected from the group consisting of methylcellulose, hydroxypropyl-methylcellulose, hydroxybutyl-methylceilulose, and combinations thereof.

15. The method of forming rigid batting material of claim 11, further comprising the step of compressing the batting after gelation of the binder, and maintaining the compression while evaporating water from the batting layer.

16. The method of forming rigid batting material of claim 11, wherein the step of applying an aqueous solution of the binder comprises saturating the batting layer with the aqueous solution.

17. The method of forming rigid batting material of claim 11, wherein the aqueous solution is from 0.1 wt % to about 5.0 wt % binder.

18. The method of forming rigid batting material of claim 11, further comprising the step of incorporating the rigid batting material into a blanket.

19. The method of forming rigid batting material of claim 11, wherein the pre-formed ceramic fiber batting is chopped fiber that has been vacuum formed upon a screen.

20. A method of forming a rigid ceramic batting, comprising the steps of:
forming a slurry of water, ceramic fibers, and a binder dissolved within the water;
vacuum forming the slurry into a green batting layer; and,
heating the green batting layer to a temperature above the gelling temperature of the binder solution.

21. The method of forming a rigid ceramic batting of claim 20, wherein the binder is a cellulose derivative having reverse thermal gelation characteristics in aqueous solution.

22. The method of forming a rigid ceramic batting of claim 21, wherein the binder is selected from the group consisting of methylcellulose and methylcellulose derivatives.

23. The method of forming a rigid ceramic batting of claim 22, wherein the binder is selected from the group consisting of methylcellulose, hydroxypropyl-methylcellulose, hydroxybutyl-methylcellulose, and combinations thereof.

24. The method of forming a rigid ceramic batting of claim 20, wherein the aqueous solution is from 0.1 wt % to about 5.0 wt % binder.

25. The method of forming a rigid ceramic batting of claim 20, further comprising the step of incorporating the rigid ceramic batting into a blanket.
